(19) United States
(12) Patent Application Publication
(10) Pub. No.: US 2020/0130410 A1
(43) Pub. Date: Apr. 30, 2020

(54) VEHICLE WHEEL AND METHOD OF MANUFACTURING THE VEHICLE WHEEL

(71) Applicant: HONDA MOTOR CO., LTD., Tokyo (JP)

(72) Inventors: Youichi KAMIYAMA, Wako-shi (JP); Yuta SHIMAMURA, Wako-shi (JP); Mikiharu NAKANISHI, Wako-shi (JP); Takuro HAMA, Wako-shi (JP)

(21) Appl. No.: 16/659,699

(22) Filed: Oct. 22, 2019

(30) Foreign Application Priority Data
Oct. 26, 2018 (JP) 2018-201550

(51) Int. Cl. B60B 21/12; G10K 11/172

(52) U.S. Cl. CPC B60B 21/12; B60B 2310/30; B60B 2900/133; G10K 11/172

(57) ABSTRACT

A vehicle wheel includes: a pair of rail members configured as separate members from the rim and fixed to an outer circumferential surface of a well portion of a rim; and a sub air chamber member serving as a Helmholtz resonator and disposed between and supported by the rail members. A distance between the pair of rail members in a wheel width direction becomes gradually narrower from the outer circumferential surface of the well portion toward outside in a wheel radial direction that is orthogonal to the wheel width direction. Further, the pair of rail members have inner surfaces located to face the outer circumferential surface in the wheel radial direction, and the sub air chamber member has a contour to conform with the inner surfaces of the pair of rail members.

### CROSS-REFERENCE TO RELATED APPLICATION

This application claims the benefit of foreign priority to Japanese Patent Application No. JP2018-201550, filed Oct. 26, 2018, which is incorporated by reference in its entirety.

### TECHNICAL FIELD

The present invention relates to a vehicle wheel and a method of manufacturing the vehicle wheel.

### BACKGROUND ART

A vehicle wheel with a Helmholtz resonator (sub air chamber member) provided on an outer circumferential surface of a well portion of a rim has been known, for example, from Japanese Patent No. 5,657,309. Helmholtz resonator is provided to reduce air-column resonance noise within a tire air chamber. The sub air chamber member of this wheel has a sub air chamber inside the sub air chamber member. The sub air chamber member includes a main body portion extending long in a wheel circumferential direction, and a pair of board-like edge portions provided on both sides of the main body portion along generally entire length of the main body portion and protruding outward in a wheel width direction. Further, the wheel has a pair of groove portions formed by cutting a pair of well-portion rising walls on a well portion so that ends of the edge portions of the sub air chamber member are fitted into the groove portions.

The sub air chamber member is attached to the outer circumferential surface of the well portion by fitting the edge portions thereof into the corresponding groove portions.

However, in the conventional wheel such as disclosed in JP5,657,309B, the edge portions and the main body portion are formed in one-piece, so that the size of the main body portion in the wheel width direction is limited by the edge portions. The conventional wheel has a disadvantage that the sub air chamber formed inside the main body portion is not enlarged to ensure a sufficiently large volume.

Further, in the cutting process of the groove portions, settings of a cutting tool have to be changed every time one of the pair of groove portions is formed. For this reason, the groove portion forming process for the conventional wheel is time-consuming, which disadvantageously leads to an increase in the manufacturing cost of the wheel.

In view of the above, the present invention seeks to provide a vehicle wheel equipped with a Helmholtz resonator (sub air chamber member), in which the volume of the sub air chamber can be enlarged as compared with the conventional wheel, while reducing the manufacturing cost. The present invention also seeks to provide a method of manufacturing such a vehicle wheel.

### SUMMARY

The present invention proposed to attain the above object provides a vehicle wheel comprising: a pair of rail members fixed to an outer circumferential surface of a well portion of a rim of a wheel, the pair of rail members being separate members from the rim; and a sub air chamber member serving as a Helmholtz resonator, the sub air chamber member being disposed between the rail members and supported by the rail members, wherein a distance between the pair of rail members in a wheel width direction becomes gradually narrower from the outer circumferential surface of the well portion toward outside in a wheel radial direction that is orthogonal to the wheel width direction, and wherein the pair of rail members have inner surfaces located to face the outer circumferential surface in the wheel radial direction, and the sub air chamber member has a contour to conform with the inner surfaces of the pair of rail members.

The present invention also provides a method of manufacturing the above-described vehicle wheel, the method comprising: a first step of disposing the sub air chamber member on the outer circumferential surface of the well portion at a predetermined position, and a second step of fixing the pair of rail members to the outer circumferential surface of the well portion after the first step.

### BRIEF DESCRIPTION OF THE DRAWINGS

FIG. 1 is an enlarged perspective view partly showing a vehicle wheel according to one embodiment of the present invention.

FIG. 2 is an exploded perspective view illustrating the vehicle wheel of FIG. 1.

FIG. 3 is a sectional view of the vehicle wheel taken on the line of FIG. 1.

FIGS. 4A to 4C are views illustrating a manufacturing process of the vehicle wheel.

FIG. 5A is a view explaining a structure of the vehicle wheel according to a first modification, and FIG. 5B is a view explaining a structure of the vehicle wheel according to a second modification.

### DETAILED DESCRIPTION OF THE INVENTION

A vehicle wheel according one embodiment of the present invention will be described below with reference to the drawings where appropriate. In the drawings to be referred to, “X” represents a circumferential direction of a wheel (i.e., wheel circumferential direction), “Y” represents a wheel width direction, and “Z” represents a radial direction of the wheel (i.e., wheel radial direction).

As a main feature, a vehicle wheel according to this embodiment includes a pair of rail members fixed to an outer circumferential surface of a well portion of a rim of a wheel, and a sub air chamber member serving as a Helmholtz resonator, wherein the pair of rail members are separate members from the rim, and the sub air chamber member is attached to the well portion through the pair of rail members. Further, in this vehicle wheel, the pair of rail members have inner surfaces located to face the outer circumferential surface in the wheel radial direction, and the sub air chamber member has a contour to conform with the inner surfaces of the pair of rail members.

In the following description, the overall structure of the vehicle wheel will be described, and thereafter rail members and a sub air chamber member will be described in detail.

### Overall Structure of Vehicle Wheel

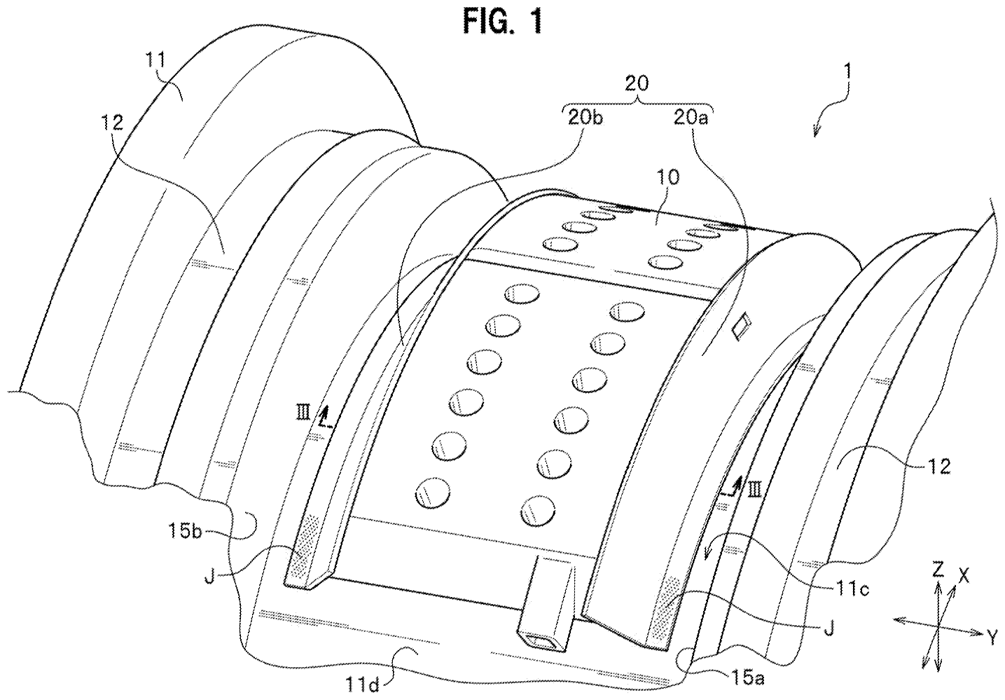

FIG. 1 is an enlarged perspective view partly showing a vehicle wheel 1 according to this embodiment; in this figure, a sub air chamber member 10 serving as a Helmholtz resonator is attached to an outer circumferential surface 11d of a well portion 11c of a wheel through rails 20.

As seen in FIG. 1, the vehicle wheel 1 according to this embodiment is configured such that a sub air chamber member 10 (Helmholtz resonator) made of synthetic resin such as polypropylene and polyamide is attached to a rim 11. The rim 11 is made of light metal such as aluminum alloy and magnesium alloy. According to this embodiment, the rim 11 may be a cast product, and the rails 20 may be an extruded product of the same light metal of which the rim 11 is made. The sub air chamber member 10 may be a blow-molded product.

Although not shown in FIG. 1, a disc by which a hub and the rim 11 are connected is disposed on the left side of the wheel (left side of the drawing sheet in the wheel width direction Y).

The rim 11 has a well portion 11c between bead seat portions 12, 12 that are formed on end portions of the rim 11 in the wheel width direction Y; the well portion 11c is recessed radially inward toward the center of the vehicle wheel 1. An outer circumferential surface 11d of the well portion 11c that is defined by the bottom surface of the recessed portion extends around the wheel axis and has substantially the same radius throughout the wheel width direction Y.

The rim 11 has a first vertical wall 15a and a second vertical wall 15b. These vertical walls 15a, 15b are spaced apart by a predetermined distance in the wheel width direction Y and rise outward from the outer circumferential surface 11d in the wheel radial direction Z.

According to this embodiment, each of the first vertical wall 15a and the second vertical wall 15b may be a rising portion that rises from the outer circumferential surface 11d of the well portion 11c toward the rim flange. In other words, the first vertical wall 15a and the second vertical wall 15b are spaced apart from each other by a predetermined distance and extend annularly in the wheel circumferential direction X, so that the vertical walls 15a, 15b are arranged opposite to each other.

### Rails

As seen in FIG. 1, the rails 20 according to this embodiment consists of a pair of rail members 20a, 20b. The rail members 20a, 20b are disposed on both sides of the sub air chamber member 10 in the wheel width direction Y.

The rail member 20a is disposed inward of the first vertical wall 15a in the wheel width direction Y adjacent to the first vertical wall 15a. The rail member 20b is disposed inward of the second vertical wall 15b in the wheel width direction Y adjacent to the second vertical wall 15b.

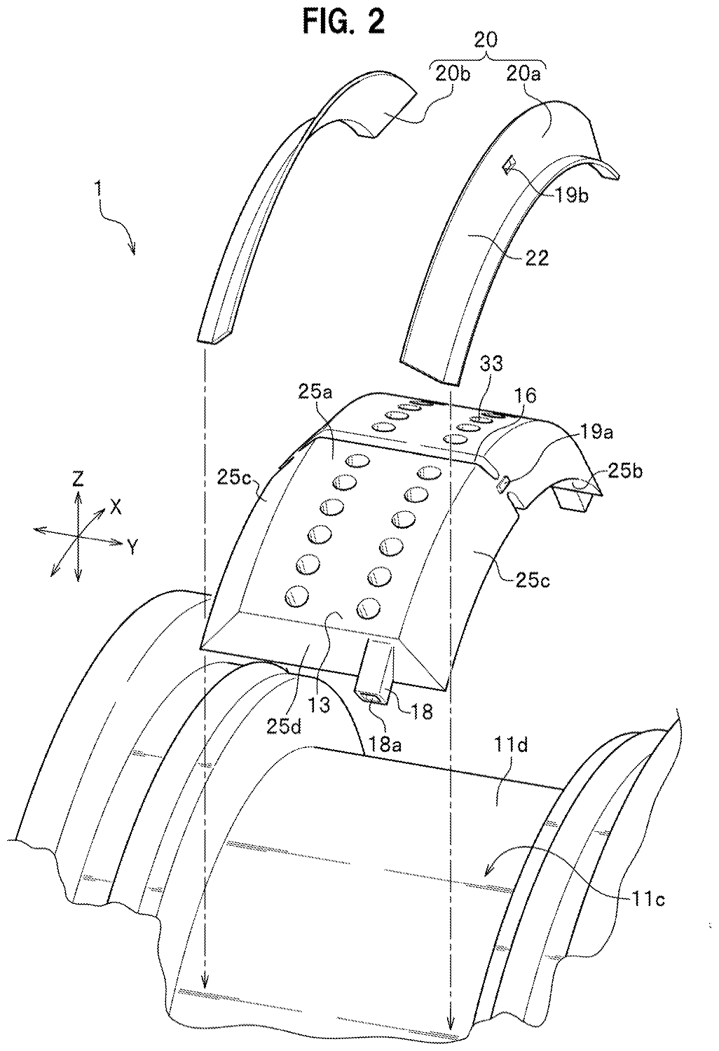

FIG. 2 is an exploded perspective view illustrating the vehicle wheel 1 of FIG. 1; in this figure, the rails 20 and the sub air chamber member 10 are illustrated.

The rail members 20a, 20b constituting the rails 20 are circularly curved members extending in the wheel circumferential direction X.

In this embodiment, the length of the rail members 20a, 20b in the wheel circumferential direction X is substantially equal to the length of a main body portion 13 (which will be described later) of the sub air chamber member 10 in the wheel circumferential direction X.

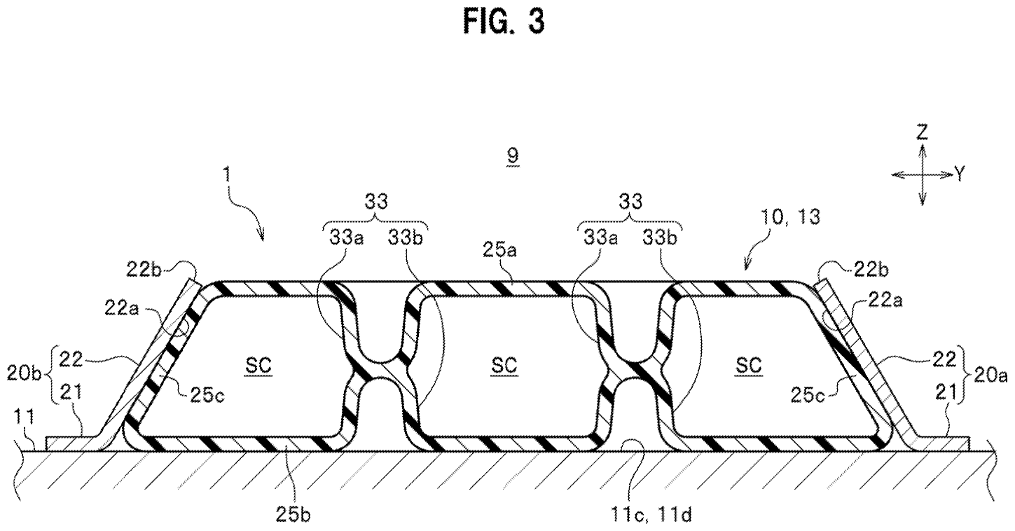

FIG. 3 is a sectional view of the vehicle wheel 1 taken on the line of FIG. 1.

As seen in FIG. 3, the rail members 20a, 20b according to this embodiment are symmetrical in shape about the sub air chamber member 10 disposed therebetween.

Each of the rail members 20a, 20b includes a base portion 21 and a support portion 22, which are formed of board members. The base portion 21 and the support portion 22 are integrally formed in one-piece to have a hockey stick-shape as viewed in a section taken on the wheel radial direction Z (i.e., section taken on a plane orthogonal to the wheel circumferential direction X, in which the pair of rail members 20a, 20b extend).

The base portion 21 is disposed along the outer circumferential surface 11d of the well portion 11c.

The support portion 22 is formed to rise from an inner end portion of the base portion 21 in the wheel width direction Y and to extend in an obliquely inward and upward direction. In other words, the support portion 22 slants such that the more it extends inward in the wheel width direction Y, the farther it is located from the outer circumferential surface 11d toward outside in the wheel radial direction Z.

According to this embodiment, an angle (bent angle) between the base portion 21 and the support portion 22 is exactly the same in each of the rail members 20a, 20b. However, if angles made between the support portions 22 and the outer circumferential surface 11d of the well portion 11c are acute angles at an inner region of the pair of rail members 20a, 20b in the wheel width direction Y, the bent angle of the rail member 20a and the bent angle of the rail member 20b may be different from each other.

According to the vehicle wheel 1 equipped with the rails 20 as described above, the distance between the support portions 22 of the pair of rail members 20a, 20b in the wheel width direction Y become gradually narrower from the outer circumferential surface 11d of the well portion 11c toward outside in the wheel radial direction Z.

Further, the pair of rail members 20a, 20b have inner surfaces 22a located to face the outer circumferential surface 11d in the wheel radial direction Z, and the sub air chamber member 10 has side plates 25c (which will be described later) disposed to follow the inner surfaces 22a of the pair of rail members 20a, 20b, so that the contour of the sub air chamber member 10 conforms with the inner surfaces 22a of the pair of rail members 20a, 20b. With this configuration, the sub air chamber member 10 is supported by the support portions 22 as will be described later.

As seen in FIG. 2, an engagement hole 19b is formed in the support portion 22 of the rail member 20a; an engagement projection 19a is formed on a side plate 25c (which will be described later) of the sub air chamber member 10, and the engagement projection 19a is to be fitted into the engagement hole 19b. As will be described later, the engagement projection 19a and the engagement hole 19b constitute a “circumferential displacement restraint portion” by which a displacement of the sub air chamber member 10 in the wheel circumferential direction X is restrained.

The rail members 20a, 20b configured as described above are fixed to the outer circumferential surface 11d of the well portion 11c by friction stir welding (FSW) only at both end portions thereof in the wheel circumferential direction X. In FIG. 1, welds J of the rail members 20a, 20b, by which the rail members 20a, 20b are fixed to the well portion 11c by friction stir welding, are shown as dotted areas; in FIG. 1 only the front welds J are illustrated in the drawing, and rear welds are omitted for the sake of convenience of illustration.

### Sub Air Camber Member

Next, with reference to FIG. 2, the sub air chamber member 10 will be described.

As seen in FIG. 2, the sub air chamber member 10 is a member extending long in one direction. The sub air chamber 10 includes a main body portion 13, and a pair of tubular portions 18 each having a communicating hole 18a.

The sub air chamber member 10 is configured to have a symmetrical shape in the wheel circumferential direction X about a partition wall 16 that extends in the wheel width direction Y and is disposed at a central portion of the main body portion 13.

The main body portion 13 curves in its longitudinal direction, so that when the sub air chamber member 10 is attached to the outer circumferential wall 11d of the well portion 11c, the main body portion 13 is disposed to extend in the wheel circumferential direction X.

The main body portion 13 has a hollow inner portion. This hollow portion (not shown in the drawings) forms a sub air chamber SC (see FIG. 3) to be described later. The hollow portion is divided into two halves in the wheel circumferential direction X by the partition wall 16. The partition wall 16 is formed by a top plate 25a and a bottom plate 25b (which will be described later) that are recessed to form grooves extending in the wheel width direction Y. Further, although not show in the drawings, the partition wall 16 is formed of the top plate 25a and the bottom plate 25b that are joined together at a generally central portion therebetween.

FIG. 3 is a sectional view of the vehicle wheel 1 taken on the line of FIG. 1. As seen in FIG. 3, the main body portion 13 of the sub air chamber member 10 has an isosceles trapezoidal shape extending long in the wheel width direction Y as viewed in a section taken on a plane orthogonal to the longitudinal direction (i.e., wheel circumferential direction X in FIG. 1).

To be more specific, the main body portion 13 includes the top plate 25a, the bottom plate 25b, and side plates 25c.

The bottom plate 25b is a board member extending in the outer circumferential surface 11d of the well portion 11c. To be more specific, the bottom plate 25b is formed to have a generally flat shape in the wheel width direction Y, the width of the bottom plate 25a in the wheel width direction Y is substantially equal to the distance between lower ends (proximal ends) of the rail members 20a, 20b. The bottom plate 25b curves in the wheel circumferential direction X (see FIG. 1) with a curvature substantially the same as that of the outer circumferential surface 11d.

The top plate 25a curves with a predetermined radius of curvature in the wheel circumferential direction X (see FIG. 1) so that the top plate 25a and the bottom plate 25b are spaced apart by a predetermined distance and opposite to each other.

According to this embodiment, the height of the top plate 25a from the outer circumferential surface 11d is substantially equal to the height of distal ends (outer edges located away from the outer circumferential surface 11d in the wheel radial direction Z) 22b of the rail members 20a, 20b. In other words, the length of the top plate 25a in the wheel width direction Y is substantially equal to the distance between the distal ends 22b of the rail members 20a, 20b.

The sub air chamber SC is formed between the top plate 25a and the bottom plate 25b. Each of the side plates 25c has a proximal end disposed at an end portion of the bottom plate 25b in the wheel width direction Y, and extends from the proximal end toward an end portion of the top plate 25a. The side plates 25c are connected to the end portions of the top plate 25a.

With this configuration, the pair of side plates 25c adjoin the inner surfaces 22a of the rail members 20a, 20b to follow shapes of the inner surfaces 22a.

In other words, the sub air chamber member 10 is configured such that the width of the main body portion 13 of the sub air chamber member 10 (i.e., length of the main body portion 13 in the wheel width direction Y) becomes gradually wider toward the outer circumferential surface 11d of the well portion 11c to match the distance between the pair of rail members 20a, 20b.

Further, as seen in FIG. 2, the main body portion 13 includes at end portions thereof in the wheel circumferential direction X side plates 25d configured to connect the top plate 25a and the bottom plate 25b.

In this embodiment, the sub air chamber member 10 is configured to have a symmetrical shape in the wheel circumferential direction X about the partition wall 16. Although not shown in the drawings for the sake of convenience of illustration, the side plates 25d according to this embodiment are provided in pair at both longitudinal end portions of the main body portion 13 (end portions in the wheel circumferential direction X); the side plates 25d are disposed at positions symmetrical to each other.

Further, as seen in FIG. 2, the main body portion 13 has a plurality of bridges 33 formed at regular intervals in the wheel circumferential direction X. The bridges 33 are arranged in two rows in the wheel width direction Y.

As seen in FIG. 3, the bridges 33 are formed by joining upper joint portions 33a and lower joint portions 33b at a generally central portion between the top plate 25a and the bottom plate 25b.

It should be noted that the upper joint portions 33a are formed of the top plate 25a partly recessed toward the bottom plate 25b. Similarly, the lower joint portions 33b are formed of the bottom plate 25b partly recessed toward the top plate 25a.

Each of the bridges 33 is generally circular cylindrical in shape and partly connects the top plate 25a and the bottom plate 25b. To be more specific, as viewed in a plan view, the upper joint portions 33a and the lower joint portions 33b are circular in shape, and the upper joint portions 33a and the lower joint portions 33b are superposed in the upper-lower direction to form generally circular cylindrical bridges 33.

Next, the tubular portions 18 will be described below.

As seen in FIGS. 1 and 2, the tubular portions 18 are formed on the main body portion 13 at positions offset toward one side of the main body portion 13 in the wheel width direction Y; the tubular portions 18 protrude from the main body portion 13 in the wheel circumferential direction X.

As described above, the sub air chamber member 10 according to this embodiment is configured to have a symmetrical shape in the wheel circumferential direction X about the partition wall 16. Therefore, a tubular portion 18 is provided on each longitudinal end portion of the main body portion 13 (i.e., end portion of the main body portion 13 in the wheel circumferential direction X); a pair of tubular portions 18 are disposed at positions symmetrical to each other. In this embodiment, the pair of tubular portions 18 are arranged at positions approximately 90 degrees apart from each other around a wheel rotation axis. Further, as seen in FIG. 2, a communicating hole 18a is formed inside the tubular portion 18. The sub air chamber SC that is formed inside the main body portion 13 (see FIG. 3) and a tire air chamber 9 (see FIG. 3) that is formed between the well portion 11c (see FIG. 3) and a tire (not shown) are in communication with each other through the communicating hole 18a.

Method of Manufacturing Wheel

The manufacturing method of the vehicle wheel 1 according to this embodiment will be described below.

The method of manufacturing the vehicle wheel 1 according to this embodiment includes: a first step of disposing the sub air chamber member 10 (see FIG. 2) on the outer circumferential surface 11d of the well portion 11c (see FIG. 2) at a predetermined position; and a second step of fixing the pair of rail members 20a, 20b (see FIG. 2) to the outer circumferential surface 11d of the well portion 11c after the first step.

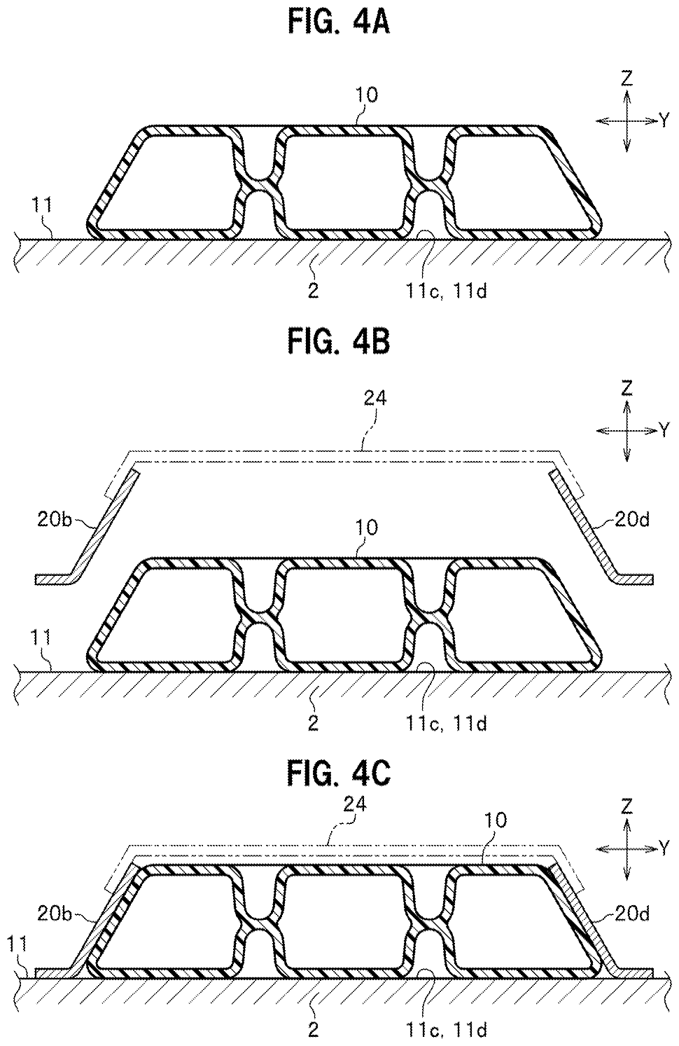

FIGS. 4A to 4C are views illustrating a manufacturing process of the vehicle wheel 1. According to this manufacturing method, as seen in FIG. 4A, the sub air chamber member 10 is disposed on a wheel body 2 that has been prepared in advance (i.e., first step).

The wheel body 2 is a cast product with a structure of the rim 11 as described above (see FIG. 1). However, the wheel body 2 may be a product available on the market with the structure of the rim 11.

In the manufacturing method according to this embodiment, the sub air chamber member 10 is disposed on a generally central portion of the outer circumferential surface 11d of the well portion 11c in the wheel width direction Y.

Next, as seen in FIG. 4B, a pair of rail members 20a, 20b are prepared in advance in this manufacturing method.

The rail members 20a, 20b are held spaced apart from each other by a predetermined distance using a jig 24. For the sake of convenience of illustration, the jig 24 is indicated by the phantom line (chain double-dashed line) in FIG. 4 B.

With the use of the jig 24, it is possible to improve the degree of positioning accuracy of the rail members 20a, 20b against the sub air chamber member 10. It is also possible to improve the degree of positioning accuracy of the rail members 20a, 20b on the outer circumferential surface 11d of the well portion 11c at positions where the rail members 20a, 20b are to be welded.

The jig 24 according to this embodiment may be formed of a narrow and long board-like member to which the rail members 20a, 20b are to be fixed by screws. However, as long as the jig 24 can removably connect the rail members 20a, 20b spaced apart from each other by a predetermine distance, the shape of the jig 24 and means for connecting the rail members 20a, 20b are not limited to a particular configuration.

Next, as seen in FIG. 4C, the pair of rail members 20a, 20b are fixed to the outer circumferential surface 11d of the well portion 11c in this manufacturing method (i.e., second step).

To be more specific, the rail members 20a, 20b held spaced apart by a predetermined distance using the jig 24 are disposed such that the support portions 22 thereof come into contact with the side plates 25c of the sub air chamber member 10. At this position, the engagement projection 19a (see FIG. 2) formed on the sub air chamber member 10 is fitted into the engagement hole 19b (see FIG. 2) of the rail member 20a.

Thereafter, as described above, the end portions of the rail members 20a, 20b in the wheel circumferential direction X (see FIG. 1) are fixed to the outer circumferential surface 11d by friction stir welding (see FIG. 1).

The jig 24 as indicated by the phantom line (chain double-dashed line) in FIG. 4 A is removed from the rail members 20a, 20b after the rail members 20a, 20b are fixed to the outer circumferential surface 11d.

### Operation and Effects

Operation and effects of the vehicle wheel 1 according to this embodiment will be described below.

According to the vehicle wheel 1, the sub air chamber member 10 is fixed to the rim through the pair of rail members 20a, 20b configured as separate members from the rim and fixed to the outer circumferential surface 11d of the well portion 11c of the rim 11. According to this vehicle wheel 1, unlike the conventional vehicle wheel (for example, disclosed in Japanese Patent No. 5,657,309), it is not necessary to cut the well-portion rising walls to provide groove portions for fixing a Helmholtz resonator. Accordingly, the vehicle wheel 1 can reduce the manufacturing cost.

Further, according to this vehicle wheel 1, the pair of rail members 20a, 20b have inner surfaces 22a located to face the outer circumferential surface 11d in the wheel radial direction Z, and the sub air chamber member 10 has a contour to conform with the inner surfaces 22a of the pair of rail members 20a, 20b.

To be more specific, the width of the sub air chamber member 10 becomes gradually wider toward the outer circumferential surface 11d of the well portion 11c to match the distance between the pair of rail members 20a, 20b.

As described above, the conventional vehicle wheel (for example, disclosed in Japanese Patent No. 5,657,309) is configured such that the main body portion is supported by the rim at the pair of board-like edge portions provided on both sides of the main body portion. However, in this conventional vehicle wheel, the size of the main body portion in the wheel width direction is limited by the edge portions. For this reason, the conventional vehicle wheel has a disadvantage that the sub air chamber formed inside the main body portion is not enlarged to ensure a sufficient volume.

In contrast, the vehicle wheel 1 according to this embodiment is configured such that the side plates 25c of the main body portion 13 are directly supported by the inner surfaces 22a of the rail members 20a, 20b.

According to the vehicle wheel 1, unlike the conventional vehicle wheel (for example, disclosed in Japanese Patent No. 5,657,309), the size of the main body portion 13 can be enlarged in the wheel width direction Y. With this construction of the sub air chamber member 10 of the vehicle wheel 1, since a larger volume of the sub air chamber SC can be ensured, a more excellent noise reduction performance can be obtained as compared with the conventional vehicle wheel.

Further, according to the vehicle wheel 1, the entire inner surfaces 22a of the rail members 20a, 20b can receive a centrifugal force exerted on the sub air chamber member 10 during the rotation of the wheel. With this configuration of the vehicle wheel 1, unlike the conventional vehicle wheel (for example, disclosed in Japanese Patent No. 5,657,309) in which ends of the edge portions receive the centrifugal force, the centrifugal force can be scattered. In other words, according to this vehicle wheel 1, it is possible to further improve the holdability of the sub air chamber member 10 on the outer circumferential surface 11d of the well portion 11c during the rotation of the wheel.

Further, according to this vehicle wheel 1, the engagement projection 19a formed on the sub air chamber member 10 is fitted into the engagement hole 19b formed in the rail member 20a. Providing the engagement projection 19a and the engagement hole 19b (i.e., circumferential displacement restraint portion) can restrain a displacement of the sub air chamber member 10 in the wheel circumferential direction X during the rotation of the wheel. With this configuration of the vehicle wheel 1, the sub air chamber member 10 can be stably held on the outer circumferential surface 11d of the well portion 11c. Accordingly, the vehicle wheel 1 can enhance more reliably the holdability of the sub air chamber member 10 against the outer circumferential surface 11d of the well portion 11c.

It should be noted that the circumferential displacement restraint portion according to this embodiment is constituted by the rails 20 and the sub air chamber member 10. However, the circumferential displacement restraint portion may be constituted by either one of the rails 20 and the sub air chamber member 10.

For example, the circumferential displacement restraint portion may be constituted by a rib (not shown) extending from the end face of each of the rail member 20a, 20b in the wheel circumferential direction X toward the end face of the sub air chamber member 10 in the wheel circumferential direction X. As an alternative, the circumferential displacement restraint portion may be constituted by a pair of ribs (not shown) extending from the end face of the sub air chamber member 10 in the wheel circumferential direction X toward the end faces of the rail members 20a, 20b in the wheel circumferential direction X.

Further, the rails 20 are friction stir welded to the outer circumferential surface 11d of the well portion 11c.

According to this vehicle wheel 1, even if the rim 11 and the rails 20 are made of a material such as aluminum alloy and they are difficult to be welded together, it is possible to join the rim 11 and the rails 20 firmly by simple process.

Further, according to the manufacturing method of the vehicle wheel 1, the rail members 20a, 20b are fixed to the outer circumferential surface 11d of the well portion 11c after the sub air chamber member 10 is disposed on the outer circumferential surface 11d of the well portion 11c.

According to this manufacturing method, positioning of the sub air chamber member 10 on the outer circumferential surface 11d of the well portion 11c and positioning of the rail members 20a, 20b on the outer circumferential surface 11d of the well portion 11c at positions where the rail members 20a, 20b are to be welded can be performed simultaneously. Accordingly, the manufacturing method of the vehicle wheel 1 can be simplified.

According to the manufacturing method of the vehicle wheel 1, the rail members 20a, 20b are spaced apart by a predetermined distance and fixed using the jig 24 in the second step.

According to this manufacturing method, it is possible to further improve the degree of positioning accuracy when the rail members 20a, 20b are fixed to the outer circumferential surface 11d to be spaced apart from each other by a predetermined distance based on the design of the rail members 20a, 20b.

In particular, great advantageous effects can be obtained by the jig 24 in the manufacturing method according to this embodiment, because a force of the tool is applied to the rail members 20a, 20b during the friction stir welding.

Although one preferred embodiment of the present invention has been described above, the present invention is not limited to the above-described embodiment, and various changes and/or modifications may be made without departing from the scope of the claims.

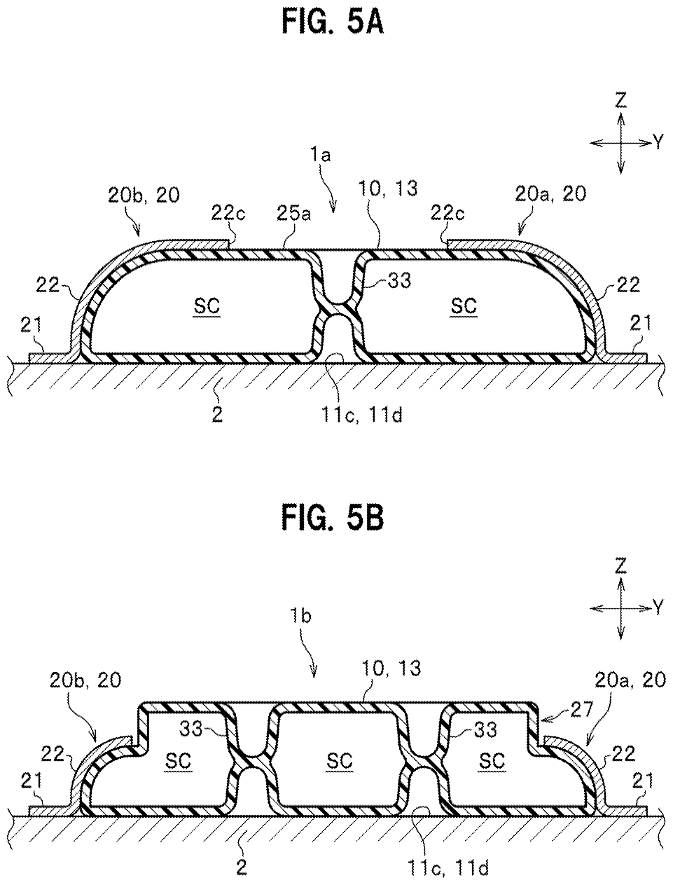

FIGS. 5A and 5B to be referred to are views explaining structures of the vehicle wheel according to modifications.

As seen in FIG. 5A, the vehicle wheel la according to the first modification is configured such that the support portions 22 of the pair of rail members 20a, 20b curve outward in the wheel radial direction Z as viewed in a section taken on a plane orthogonal to the wheel width direction Y and the wheel radial direction Z (see FIG. 1).

Further, the support portions 22 of the pair of rail members 20a, 20b have inner surfaces located to face the outer circumferential surface 11d of the well portion 11c in the wheel radial direction Z, and the sub air chamber member 10 is formed to follow the inner surfaces of the support portions 22.

With this configuration of the vehicle wheel la, a larger volume of the sub air chamber SC can be ensured as compared with the vehicle wheel 1 equipped with the rail members 20a, 20b (support portions 22) slanted with respect to the outer circumferential surface 11d (see FIG. 3).

Further, in this vehicle wheel la, upper end portions (i.e., distal ends) 22c of the support portions 22 may extend inward in the wheel width direction Y.

With this configuration of the vehicle wheel la, the upper end portions 22c of the support portions 22 partly cover the top plate 25a of the sub air chamber member 10, so that the number of rows of bridges 33 arranged in the wheel width direction Y can be decreased.

As seen in FIG. 5B, the vehicle wheel 1b according to the second modification is configured such that the sub air chamber member 10 has a bulged portion 27 jutting out farther toward outside in the wheel radial direction Z beyond the upper end portions 22c of the support portions 22.

With this configuration of the vehicle wheel lb, providing the bulged portion 27 makes it possible to further enlarge the volume of the sub air chamber SC.

The jig 24 used in the above embodiment (see FIG. 4C) is removed from the rail members 20a, 20b after the rail members 20a, 20b are fixed to the outer circumferential surface 11d of the well portion 11c.

However, the vehicle wheel 1 may include an unremovable restraint portion for adjusting the distance between the rail members 20a, 20b.

Although not shown in the drawings, such a restraint portion may include grooves (recess portions) formed in the outer circumferential surface 11d of the well portion 11c, into which base portions 21 of the rail members 20a, 20b are respectively fitted. As an alternative, the restraint portion may include studs protruding from the outer circumferential surface 11d of the well portion 11c, with which the rail members 20a, 20b are engageable. As a further alternative, the restraint portion may be a connecting portion for connecting the rail members 20a, 20b together.

As described above, the length of the rail members 20a, 20b in the wheel circumferential direction X is substantially equal to the length of the sub air chamber member 10. However, the length of the rail members 20a, 20b may be shorter than or longer than the length of the sub air chamber member 10.

The method of manufacturing the vehicle wheel 1 according to the above-described embodiment has been described with reference to FIGS. 4A to 4C; in this method, the rail members 20a, 20b are fixed to the outer circumferential surface 11d of the well portion 11c after the sub air chamber member 10 is disposed on the outer circumferential surface 11d of the well portion 11c. However, in the manufacturing method according to the present invention, the rail members 20a, 20b may be fixed to the outer circumferential surface 11d of the well portion 11c in advance. Then, the sub air chamber member 10 may be attached to the rail members 20a, 20b by inserting the sub air chamber member 10 from one side of the rail members 20a, 20b and sliding the sub air chamber member 10 in the wheel circumferential direction X.

1. A vehicle wheel comprising:
a pair of rail members fixed to an outer circumferential surface of a well portion of a rim of a wheel, the pair of rail members being separate members from the rim; and
a sub air chamber member serving as a Helmholtz resonator, the sub air chamber member being disposed between the rail members and supported by the rail members,
wherein a distance between the pair of rail members in a wheel width direction becomes gradually narrower from the outer circumferential surface of the well portion toward outside in a wheel radial direction that is orthogonal to the wheel width direction, and
wherein the pair of rail members have inner surfaces located to face the outer circumferential surface in the wheel radial direction, and the sub air chamber member has a contour to conform with the inner surfaces of the pair of rail members.

2. The vehicle wheel according to claim 1, wherein a width of the sub air chamber member becomes gradually wider toward the outer circumferential surface of the well portion to match the distance between the pair of rail members.

3. The vehicle wheel according to claim 1, wherein the pair of rail members curve outward in the wheel radial direction as viewed in a section taken on a plane orthogonal to a wheel circumferential direction that is orthogonal to the wheel width direction and the wheel radial direction.

4. The vehicle wheel according to claim 3, wherein the sub air chamber member has a bulged portion jutting out farther toward outside in the wheel radial direction beyond distal ends of the pair of rail members.

5. The vehicle wheel according to claim 1, wherein each of the rail members comprises a base portion disposed along the outer circumferential surface of the well portion, and a support portion integral with the base portion and configured to extend from an inner end portion of the base portion in the wheel width direction such that the more it extends inward in the wheel width direction, the farther it is located from the outer circumferential surface in the wheel radial direction.

6. A method of manufacturing a vehicle wheel according to claim 1, the method comprising:
a first step of disposing the sub air chamber member on the outer circumferential surface of the well portion at a predetermined position, and
a second step of fixing the pair of rail members to the outer circumferential surface of the well portion after the first step.
